(19) United States
(12) Patent Application Publication
(10) Pub. No.: US 2012/0239791 A1
(43) Pub. Date: Sep. 20, 2012

(54) Network System, Network Configuration Method, And Network Configuration Device

(75) Inventor: Akio Takamoto, Nagano-ken (JP)

(73) Assignee: Seiko Epson Corporation, Tokyo (JP)

(21) Appl. No.: 13/404,251

(22) Filed: Feb. 24, 2012

(30) Foreign Application Priority Data
Mar. 16, 2011 (JP) 2011-057870
Mar. 16, 2011 (JP) 2011-057878

(51) Int. Cl. G06F 15/177

(52) U.S. Cl. 709/222

(57) ABSTRACT

A storage unit stores configuration information of a first network device connected to a network. An acquisition unit acquires information related to the operating status of the first network device. A detection unit detects if a second network device is connected to the network. A network configuration unit instructs/commands the second network device to configure itself using the configuration information of the first network device stored in the storage unit if the first network device is not operating when connection of the second network device to the network is detected.

### CROSS-REFERENCE TO RELATED APPLICATION(S)

The present application claims priority under 35 U.S.C. §119 on Japan Patent Nos. 2011-057870 and 2011-057878, each filed on Mar. 16, 2011. The content of each such related application is incorporated by reference herein.

### BACKGROUND

1. Technical Field

The present invention relates to a network system that runs a process configuring network devices. The invention relates more particularly to a network configuration method and network configuration device that can easily and without error automatically set network information when a network device is installed.

2. Related Art

Networks such as local area networks (LAN) are common today in offices and other environments, and printers and other network devices that are connected to the network can be used by issuing instructions from computers (host devices) connected to the network.

In order to enable a new network device installed in such a network environment to access the network, the IP address and other network information must be set, and the device settings must be initialized for operation. This setup operation has conventionally been done by a specialized service technician sent from the device manufacturer.

Technology related to this setup process is described in Japanese Unexamined Patent Appl. Pub. JP-A-2000-316002.

However, the setup process required to install a network device such as described above is time-consuming and requires a specialist as described above.

JP-A-2000-316002 relates to configuring a DHCP client, and does not solve the foregoing problem of configuring printers and other such network devices.

A configuration process that is handled automatically, does not rely on manual intervention, and is error-free is therefore desirable.

### SUMMARY

A network configuration method and program according to the invention performs a network device configuration process that can easily and without error configure network information, for example, when a network device is installed.

One aspect of the invention is embodied in a network system including a first network device connected to a network; a second network device connected to the network; and a host device that is connected to the first network device and second network device over the network. The host device includes a storage unit that stores configuration information including network information of the first network device, an acquisition unit that acquires information related to the operating status of the first network device, and a network configuration unit that instructs the second network device to configure itself using the configuration information of the first network device stored in the storage unit when information related to the operating status of the first network device acquired by the acquisition unit indicates that the first network device is not operating.

In another aspect of the invention, the acquisition unit preferably acquires information related to the operating status of the first network device when the second network device is connected to the network; and the network configuration unit instructs or commands the second network device to configure itself using the configuration information of the first network device based on information related to the operating status of the first network device acquired by the acquisition unit when the second network device was connected to the network.

Preferably, the first network device and the second network device are the same model.

Further preferably, the network information includes an IP address.

In another aspect of the invention, the network configuration unit detects the IP address of the second network device when the second network device is connected to the network, and if the detected IP address of the second network device is a predetermined IP address, instructs or commands the second network device to configure itself using the configuration information of the first network device.

Preferably, the first network device and second network device are printers.

In another aspect of the invention, the second network device has an automatic configuration mode that configures settings when instructed or commanded to configure itself using the configuration information of the first network device by the network configuration unit of the host device.

In another aspect of the invention, the network configuration unit of the host device detects the automatic configuration mode setting of the second network device, and instructs or commands setting the configuration information of the first network device when the automatic configuration mode is enabled.

In another aspect of the invention, the second network device has a report unit that reports when setting the configuration information is instructed or commanded by the host device.

Another aspect of the invention is embodied in a network configuration method. Such method comprises steps of: storing, in a host device, configuration information including network information of a first network device; detecting the operating status of the first network device connected to a network, detecting if the first network device is operating when a second network device is connected to the network, and commanding the second network device connected to the network to configure itself using the configuration information of the first network device when the first network device is determined to be not operating.

In another aspect of the invention, the host device determines if the second network device connected to the network is the same model as the first network device, and when the first network device and second network device are determined to be the same model, commands the second network device to configure itself using the configuration information of the first network device.

In another aspect of the invention, the host device determines if the second network device is set to an automatic configuration mode that sets the configuration information specified by the host device, and commands the second network device to configure itself using the configuration information when the second network device is set to the automatic configuration mode.

In another aspect of the invention, the network information is an IP address.

In another aspect of the invention, the host device detects the IP address of the second network device when the second network device is connected to the network, and commands the second network device to configure itself using the configuration information of the first network device when the detected IP address of the second network device is a predetermined IP address.

Preferably, the first network device and second network device are printers.

In another aspect of the invention, the second network device reports to the user when setting the configuration information is commanded by the host device.

Still another aspect of the invention is embodied in a network configuration device that includes: a storage unit that stores configuration information including network information of a first network device connected through a network; an acquisition unit that acquires information related to the operating status of the first network device; a detection unit that detects connection of a second network device to the network; and a network configuration unit that instructs the second network device to configure itself using the configuration information of the first network device stored in the storage unit when the detection unit detects the second network device is connected to the network and information related to the operating status of the first network device acquired by the acquisition unit indicates that the first network device is not operating.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram schematically illustrating a first embodiment of a host device according to embodiments of the invention.

FIG. 2 shows an example of a configuration table.

FIG. 3 is a flow chart of an automatic setup process according to the first embodiment of the invention.

FIG. 4 is a block diagram of a second embodiment of a host device and printers according to embodiments of the invention.

FIG. 5 is a flow chart showing an example of a process executed by the network configuration unit in the second embodiment of the invention.

### DESCRIPTION OF EMBODIMENTS

Preferred embodiments of the present invention are described below with reference to the accompanying figures. However, the technical scope of the invention is not limited to the embodiments described below; rather, such invention extends to elements described in the accompanying claims and equivalents thereof.

### System According to Embodiment 1

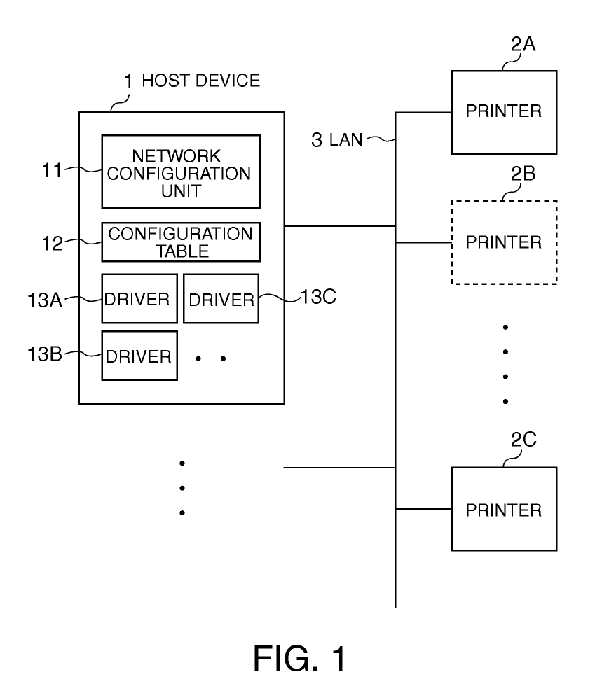

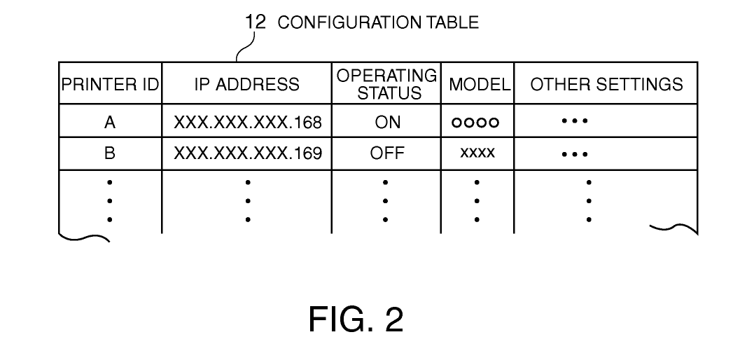

A system according to the first embodiment of the invention is described next with reference to FIGS. 1 and 2. FIG. 1 is a block diagram of a host device, and FIG. 2 shows an example of the configuration table 12.

The host device 1 (network configuration device) shown in FIG. 1 is a device according to a first embodiment of the invention. The host device 1 stores the operating status and configuration information including the IP address of each network device, including printers (2A, 2B), connected over a network (LAN 3). When a new network device (e.g., printer 2C) is connected to the network, and the devices for which configuration information is stored include a device of the same type that is not already operating, the host device 1 runs a process that sends and sets the configuration information for that device to the new device. Newly installed printers and other devices are thus automatically initialized to the operating environment by this process of the host device 1, and the need for the help of a specialist can be reduced.

As shown in FIG. 1, this host device 1 is connected to a plurality of printers 2 (printers 2A, 2B and 2C in the illustrated embodiment) over a LAN 3 (local area network), and outputs commands to the network devices to execute specific processes. For example, print commands can be sent to the printers 2 to cause them to print. There may also be a plurality of host devices 1 that send commands to the printers 2 over the LAN 3.

The host device 1 is, for example, a personal computer that can communicate over a network, and while not shown in the figures, such a host device 1 includes a CPU, RAM, hard disk drive, display device, and input devices. The functional configuration of the host device 1 includes a network configuration unit 11, configuration table 12, and a driver 13 for each printer 2 as shown in FIG. 1. In the illustrated embodiment, there are three printers 2A, 2B and 2C having drivers 13A, 13B and 13C, respectively.

The network configuration unit 11 is a feature part of the host device 1, and performs a process that updates the configuration table 12, which is stored in a storage unit as network configuration information described below, and a configuration process when a new network device is installed. The specific content of these processes is described below. Note that the network configuration unit 11 is preferably embodied by a program stored on the hard disk drive or other tangible computer-readable medium for execution by the CPU, which runs a process according to the program. This program is equivalent to a network configuration program.

The configuration table 12 may be a data table storing information that is set for each of the network devices such as printers 2 connected to the LAN 3, and is stored on, for example, the hard disk drive. FIG. 2 shows an example of this configuration table 12. Stored in the configuration table 12 for each network device are configuration information, including network information such as the IP address required for the network communication by the network device and information related to different conditions when the network device operates, information related to the operating status of the network device, and device model information.

As shown in FIG. 2, this information is stored linked to identification information for each network device, which is the printer ID of each printer 2 in this example, and the IP address, operating status information, and device model information are stored respectively in corresponding IP address, operating status, and model fields. The printer ID of printer 2A and printer 2B is simply A and B, respectively, in this example. An address suitable for use on the LAN 3 is set as the IP address. Information indicating whether or not the network device is operating is stored in the operating status field, ON being stored when the device is operating and OFF being stored when not operating. This information is acquired and updated by the network configuration unit 11 as needed. Note that an ON operating status here means that the network device power is on and the network device can be connected to over the LAN 3; the operating status is OFF when the power is off, and the operating status is OFF when the communication cable of a device that communicates by wire is not connected to the LAN 3.

The model field denotes the model of the network device, and in the example shown in FIG. 2A, printer 2A and printer 2B are different models. The other settings field stores network-related information other than the IP address, and information related to various conditions when the device operates. For example, when the device is a printer, the default print settings may be stored in this field. The content of this information is suitable for use on the LAN 3 environment.

The drivers 13 are drivers for each network device connected to and used over the LAN 3, and drivers 13A, 13B, and 13C for printers 2A, 2B, and 2C are shown in this example. The IP address of the corresponding network device is also set in the drivers 13. Note that a driver 13 is rendered by a program stored on the hard disk drive, for example, and the CPU executing a process according to the program.

Next, the printers 2 are network devices that receive commands from the host device 1 and execute printing processes, for example, and are common printers having a communication function for communicating over the LAN 3. In this embodiment of the invention shown in FIG. 1, printer 2A is a device that is already installed and is operating, printer 2B is a device that is installed but is not operating because of some failures, for example, and printer 2C is a device that is newly installed to the LAN 3.

While not shown in the figures, each printer 2 has a control unit and a print unit, and the print unit executes a printing process as controlled by the control unit according to commands received from the host device 1. The control unit has a function for communicating over the LAN 3, and executes a configuration process according to a setup command based on configuration information sent from the host device 1. The information that is set is stored in NVRAM in the printer 2, and is read and used as needed.

A feature of the host device 1 configured as described above is the automatic setup process applied to the printer 2 as described more specifically below.

### Initial Registration of the Configuration Table 12

Initial registration of the configuration table 12 is described below. The configuration table 12 preferably stores the most recent information for network devices that can be used over the LAN 3 and network devices that were used in the past and cannot currently be used but for which the configuration information is valid (the IP address is not used by another device). The configuration table 12 can be initially created and saved manually by the network administrator or automatically by the network configuration unit 11.

When configured automatically, the network configuration unit 11 receives an appropriate automatic configuration command from the user, sends a request for configuration information to the IP address assigned to each driver 13, and registers the received information in the configuration table 12. Because this information cannot be received by communication from devices that cannot be currently used, the information is input manually as required.

### Automatic Setup Process of Configuration Information Using the Configuration Table 12

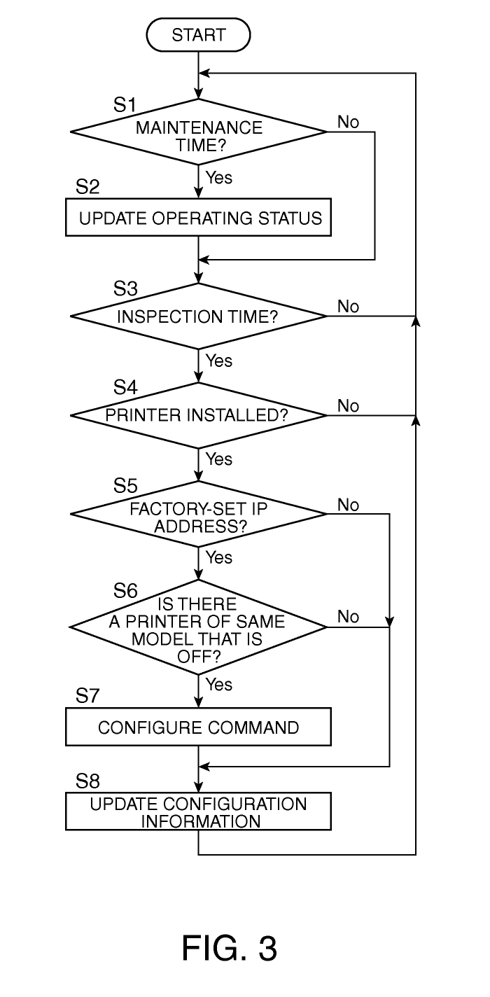

The process of automatically setting configuration information using the configuration table 12 is described next with reference to FIG. 3. FIG. 3 is a flow chart shows steps in this process.

The network configuration unit 11 operates continuously while the host device 1 is operating, and monitors the operating status and new installation of network devices (printers 2 in this example). The network configuration unit 11 also checks the operating status of the printers 2 at a predefined specific interval by an acquisition unit not shown. More specifically, the operating status information in the configuration table 12 is kept current (maintained) by repeatedly checking the status at a specific timing. When the maintenance timing comes (step S1 returns Yes), the network configuration unit 11 sends a configuration information request to the IP address specified by each driver 13, determines printers 2 that respond are ON and printers 2 that do not respond are OFF, and updates the operating status information accordingly (step S2). Note that other information in the configuration table 12 that has changed when this update process executes may also be updated at the same time.

Note that the operating status is preferably not immediately set to OFF when a response is not received, and is updated to OFF only when a response is not received after multiple requests.

If the maintenance timing has not come (step S1 returns No), and when the update process has executed, the network configuration unit 11 checks if the time to inspect the network for new devices has come (step S3). This inspection time is preset, and the network is repeatedly inspected at the specified times.

If the inspection time has not come (step S3 returns No), the process returns to step S1.

If the inspection time has come (step S3 returns Yes), the network configuration unit 11 checks if a printer 2 has been newly installed to the LAN 3 (step S4). More specifically, the network configuration unit 11 broadcasts a request for the configuration information to the LAN 3, and inspects the responses to see if information is received from a printer 2 with an IP address different from the IP addresses stored in the configuration table 12. Note that the IP address and information denoting the network device model as described above are included in the information returned from the network devices, and new devices can be found by checking this information.

If a newly installed printer 2 is not found by this inspection (step S4 returns No), the process returns to step S1.

However, if a newly installed printer 2 is found (step S4 returns Yes), the network configuration unit 11 checks if the IP address of the new printer 2 is set to the predetermined factory-set IP address (step S5). The network configuration unit 11 stores the factory-set IP addresses, or characteristics of those IP addresses, and can thereby determine if the IP address contained in the information returned from the network device is the factory-set IP address.

If this check determines that the IP address is not the factory-set IP address (step S5 returns No), the process goes to step S8. Because the possibility that the IP address of the newly installed printer 2 was intentionally set by hand in this case, that IP address and other settings are not changed automatically. Note, further, that when the newly installed printer 2 is a used product, and the user understands the function of the network configuration unit 11 and wants to configure the printer 2 automatically, the user connects the printer 2 to the LAN 3 after restoring the printer 2 to the default factory settings using a function of the printer 2, for example.

If the factory-set IP address is detected (step S5 returns Yes), the network configuration unit 11 checks the information stored in the configuration table 12 for a printer 2 that is the same model as the newly installed printer 2 but whose operating status is OFF (step S6). More specifically, the network configuration unit 11 looks for information about a printer 2 that satisfies the foregoing conditions in the configuration table 12 using the model information contained in the information returned from the printer 2.

If this check does not find a printer 2 that satisfies the conditions (step S6 returns No), the process goes to step S8. However, if this check finds a printer 2 that satisfies the conditions (step S6 returns Yes), the network configuration unit 11 outputs a command to the newly installed printer 2 to set the information stored in the configuration table 12 for the printer 2 that meets the conditions (step S7). More specifically, the network configuration unit 11 sends a command to the newly installed printer 2 to configure itself using the content of the settings of the non-operating printer 2 of the same model that were found in the configuration table 12. The controller of the newly installed printer 2 receiving this command then executes a configuration process based on this command. As a result, network information such as the IP address and information related to operating conditions are set suitably according to the LAN 3 environment, enabling the printer 2 to be used.

As described above, when printer 2C is installed to the example shown in FIG. 1 and printer 2B of the same model is not running (has been removed), the settings for printer 2B are transferred directly to printer 2C. In this case, the information for printer ID B is found in the example shown in FIG. 2, and this information is sent to printer 2C and set.

In step S8 the network configuration unit 11 then runs the process to update the information stored in the configuration table 12. Note that when step S5 returns No or step S6 returns No and the process goes to step S8, the update process adds the information set in the newly installed printer 2 to the configuration table 12. When control goes from step S7 to step S8, the printer ID and operating status are updated in the record storing the information used for the newly installed printer 2. More specifically, the printer ID is set to the ID of the newly installed printer 2, and the operating status is set to ON. In the above example that uses the configuration information of printer 2B for printer 2C, the printer ID of B shown in FIG. 2 changes to a printer ID of C, and the operating status is updated to ON.

The network inspection and automatic configuration process of the network configuration unit 11 described above executes repeatedly.

As described above, the host device 1 according to this embodiment of the invention automatically executes a configuration process including the network information of the newly installed printer 2 using the information for a previous printer 2 that was used on the same network, and can therefore easily perform a configuration process appropriate to the environment without requiring manual intervention. The work of a specialist required by the related art can therefore be eliminated.

The automatic configuration described above also does not require special configuration of the printer 2, and can be achieved relatively easily by simply installing the network configuration unit 11 to the host device 1.

The automatic configuration described above is executed when the IP address of the newly installed printer 2 is the factory-set IP address, and does not unilaterally change information that has been intentionally set manually.

Note, further, that the network device is a printer in the embodiment described above, but the invention is not so limited and can be applied to other network devices including scanners, projectors, and facsimile machines.

### System According to a Second Embodiment

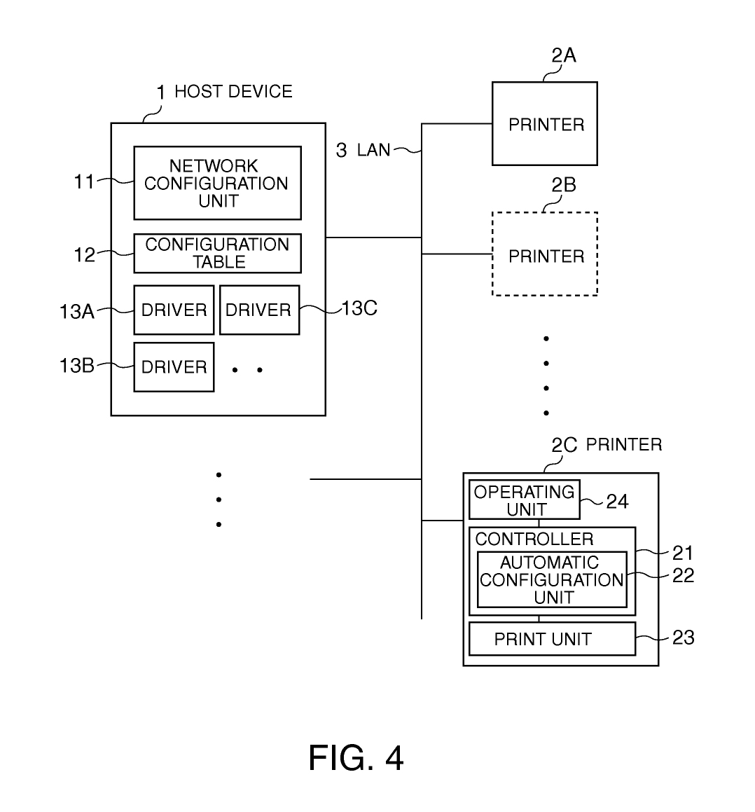

A second embodiment of the invention is described next with reference to FIG. 2 and FIG. 4. FIG. 4 is a block diagram of a second embodiment of a host device according to the invention. Note that elements that are the same as in the first embodiment are identified by the same reference numerals here, and further description thereof is omitted.

FIG. 4 shows the configuration of a second embodiment of a printer and host device according to the invention. The host device 1 stores the operating status and configuration information including the IP address of each network device, including printers (2A, 2B), connected over a network (LAN 3). When a new network device (2C) is connected to the network and the device is set to an automatic configuration mode, and the devices for which configuration information is stored include a device of the same type that is not already operating, the host device 1 runs a process that sends and sets the configuration information for that device to the new device. The printer 2 also has a function that enables the user to set the automatic configuration mode when the device is installed, and if the device is in this mode when connected to the network, the foregoing configuration command is sent from the host device 1, and the printer 2 executes the configuration process based on the configuration information. Newly installed printers and other devices are thus initialized automatically to the operating environment by this process with the concurrence of the user, thereby reducing the need for the help of a specialist. Such process can also prevent the setting of incorrect information. The automatic configuration mode as used here is a mode that executes the configuration process according to configuration information sent from the host.

In this network system as shown in FIG. 4, the host device 1 is connected to a plurality of printers 2 over a LAN 3 (local area network), and outputs commands to the network devices to execute specific processes. More particularly, primarily print commands can be sent to the printers 2 to cause them to print. There may also be a plurality of host devices 1 that send commands to the printers 2 over the LAN 3.

The host device 1 is, for example, a personal computer that can communicate over a network, and while not shown in the figures, the host 1 includes a CPU, RAM, hard disk drive, display device, and input devices. The functional configuration of the host device 1 includes a network configuration unit 11, configuration table 12, and a driver 13 for each printer 2 as shown in FIG. 1.

The network configuration unit 11 is a feature part of the host device 1, and performs a process that updates the configuration table 12, and a configuration process when a new network device is installed. The specific content of these processes is described below. Note that the network configuration unit 11 is embodied by a program stored on the hard disk drive, for example, and the foregoing CPU that runs a process according to the program, and this program is equivalent to a network configuration program.

The configuration table 12 can be a data table storing information that is set for each of the network devices such as printers 2 connected to the LAN 3, and is stored on the hard disk drive. FIG. 2 shows an example of this configuration table 12. Stored in the configuration table 12 for each network device are configuration information, including network information such as the IP address required for the network communication by the network device and information related to different conditions when the network device operates, information related to the operating status of the network device, and device model information.

As shown in FIG. 2, this information is stored linked to identification information for each network device, which is the printer ID of each printer 2 in this example, and the IP address, operating status information, and device model information are stored respectively in corresponding IP address, operating status, and model fields. The printer ID of printer 2A and printer 2B is simply A and B, respectively, in this example. An address suitable for use on the LAN 3 is set as the IP address. Information indicating whether or not the network device is operating is stored in the operating status field, ON being stored when the device is operating and OFF being stored when not operating. This information is acquired and updated by the network configuration unit 11 as needed. Note that an ON operating status means that the network device power is on and the network device can be connected to over the LAN 3; the operating status is OFF when the power is off, and the operating status is OFF when the communication cable of a device that communicates by wire is not connected to the LAN 3.

The model field denotes the model of the network device, and in the example shown in FIG. 2A, printer 2A and printer 2B are different models. The other settings field stores network-related information other than the IP address, and information related to various conditions when the device operates. For example, when the device is a printer, the default print settings may be stored in this field. The content of this information is obviously suited to use on the LAN 3 environment.

The drivers 13 are drivers for each network device connected to and used over the LAN 3, and drivers 13A, 13B, and 13C for printers 2A, 2B, and 2C are shown in this example. The IP address of the corresponding network device is also set in the drivers 13. Note that a driver 13 is rendered by a program stored on the hard disk drive, for example, and the CPU executing a process according to the program.

Next, the printers 2 are network devices that receive commands from the host device 1 and execute printing processes, for example, and are printers having a communication function for communicating over the LAN 3. In this embodiment of the invention shown in FIG. 4, printer 2A is a device that is already installed and is operating, printer 2B is a device that is installed but is not operating because of some failure, for example, and printer 2C is a device that is newly installed to the LAN 3.

As shown in printer 2C, each printer 2 has a controller 21, a print unit 23, and an operating unit 24. The controller 21 is the part that controls operation of the printer 2, including the operating unit 24 and sending a command to the print unit 23 to execute the printing process when a print command is received from the host device 1, for example. The print unit 23 is the part that executes the printing process on the print medium as controlled by the controller 21. The operating unit 24 is the part that controls the user interface of the printer 2, and includes a display panel or operating buttons, for example.

As shown in FIG. 4, the controller 21 has an automatic configuration unit 22, and the automatic configuration unit 22 controls the function related to the automatic configuration process when the printer 2 is installed to the network. The specific content of the processes executed by these parts are described below. These processes include a process in which the user enables the automatic configuration mode enabling automatic configuration by the network configuration unit 11 of the host device 1, and a process for automatically configuring the printer 2 when this automatic configuration mode is enabled. Note, further, that the automatic configuration unit 22 is rendered by a program stored in ROM in the controller 21, and a CPU disposed to the controller 21 that executes a process according to the program, for example.

The configuration information that is set by the automatic configuration unit 22 is stored in NVRAM in the printer 2, and is read and used as needed.

A feature of the network system configured as described above the host device 1 configured as described above is the automatic setup process applied to the printer 2 as described more specifically below.

### Initial Registration of the Configuration Table 12

Initial registration of the configuration table 12 is described below. The configuration table 12 preferably stores the most recent information for network devices that can be used over the LAN 3 and network devices that were used in the past and cannot currently be used but for which the configuration information is valid (the IP address is not used by another device). The configuration table 12 can be initially created and saved manually by the network administrator or automatically by the network configuration unit 11.

When configured automatically, the network configuration unit 11 receives an appropriate automatic configuration command from the user, sends a request for configuration information to the IP address assigned to each driver 13, and registers the received information in the configuration table 12. Because this information cannot be received by communication from devices that cannot be currently used, the information is input manually as required.

### Automatic Setup Process of Configuration Information Using the Configuration Table 12

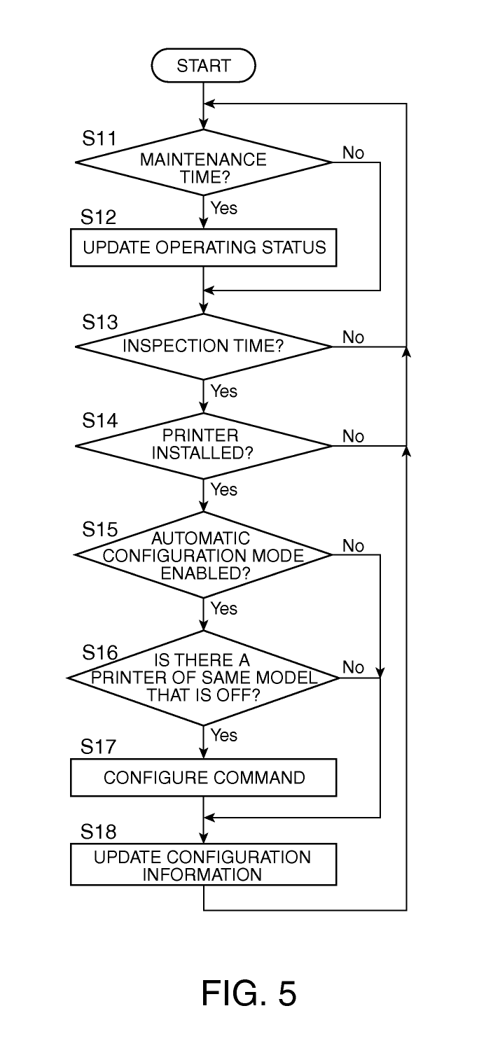

The process of automatically setting configuration information using the configuration table 12 is described next with reference to FIG. 5, which is a flow chart of the process performed by the network configuration unit in this second embodiment of the invention.

The network configuration unit 11 operates continuously while the host device 1 is operating, and monitors the operating status and new installation of network devices (printers 2 in this example). The network configuration unit 11 also checks the operating status of the printers 2 at a predefined specific interval. More specifically, the operating status information in the configuration table 12 is kept current (maintained) by repeatedly checking the status at a specific timing. When the maintenance timing comes (step S11 returns Yes), the network configuration unit 11 sends a configuration information request to the IP address specified by each driver 13, determines printers 2 that respond are ON and printers 2 that do not respond are OFF, and updates the operating status information accordingly (step S12). Note that other information in the configuration table 12 that has changed when this update process executes may also be updated at the same time.

Note that the operating status is preferably not immediately set to OFF when a response is not received, and is updated to OFF only when a response is not received after multiple requests.

If the maintenance timing has not come (step S11 returns No), and when the update process has executed, the network configuration unit 11 checks if the time to inspect the network for new devices has come (step S13). This inspection time is preset, and the network is repeatedly inspected at the specified times.

If the inspection time has not come (step S13 returns No), the process returns to step S11.

If the inspection time has come (step S13 returns Yes), the network configuration unit 11 checks if a printer 2 has been newly installed to the LAN 3 (step S14). More specifically, the network configuration unit 11 broadcasts a request for the configuration information to the LAN 3, and inspects the responses to see if information is received from a printer 2 with an IP address different from the IP addresses stored in the configuration table 12. Note that the IP address, information denoting the network device model, and the automatic configuration mode setting as described above are included in the information returned from the network devices, and new devices can be found by checking this information.

If a newly installed printer 2 is not found by this inspection (step S14 returns No), the process returns to step S11.

However, if a newly installed printer 2 is found (step S14 returns Yes), the network configuration unit 11 checks if the new printer 2 is set to the automatic configuration mode (step S15).

Note that when newly installing a printer 2 to the LAN 3, the user determines whether or not to automatically set the network information and operating condition information stored in the configuration table 12 by means of the host device 1, and sets the printer 2 to the automatic configuration mode if automatic configuration is selected. More specifically, the user enables the automatic configuration mode by performing a specific operation (such as turning the power switch on while the feed button is depressed and continuing to hold the feed button pressed for a long time) on the operating unit 24, and the automatic configuration unit 22 that receives this command stores the automatic configuration mode setting in RAM or NVRAM of the controller 21. The automatic configuration mode setting thus stored is also included in the information returned in the response to requests broadcast when a printer 2 is installed to the LAN 3.

Note that the user does not enable the automatic configuration mode when the user knows there are no printers 2 on the LAN 3 that are not used, such as when a new printer 2 is simply added, and when automatic configuration is not desirable because manual settings are required.

Returning to step S15, the network configuration unit 11 determines from the information related to the automatic configuration mode contained in the returned information if the newly installed printer 2 is set to the automatic configuration mode. Note that the network configuration unit 11 could request this information from a printer 2 determined to be newly installed and determine from the response if the automatic configuration mode is enabled instead of including this information related to the automatic configuration mode in the response to a broadcast request.

If the automatic configuration mode is not enabled (step S15 returns No), the process goes to step S18.

If the automatic configuration mode is enabled (step S15 returns Yes), the network configuration unit 11 checks the information stored in the configuration table 12 for a printer 2 that is the same model as the newly installed printer 2 but whose operating status is OFF (step S16). More specifically, the network configuration unit 11 looks for information about a printer 2 that satisfies the foregoing conditions in the configuration table 12 using the model information contained in the information returned from the printer 2.

If this check does not find a printer 2 that satisfies the conditions (step S16 returns No), the process goes to step S18. However, if there is a printer 2 that satisfies the conditions (step S16 returns Yes), the network configuration unit 11 outputs a command to the newly installed printer 2 to set the information stored in the configuration table 12 for the printer 2 that meets the conditions (step S17). More specifically, the network configuration unit 11 sends a command to the newly installed printer 2 to set the content of the settings of the non-operating printer 2 of the same model that were found in the configuration table 12.

The automatic configuration unit 22 of the controller 21 in the printer 2 receives this command, and the automatic configuration unit 22 reports to the user that the printer 2 will be automatically configured and then waits for confirmation. More specifically, a message such as “Terminal ABC will set the IP address to xxx.xxx.xxx.xxx. Press FEED once to continue. Turn the power off to CANCEL.” is displayed on the display panel of the operating unit 24. Alternatively, the print unit 23 could be instructed to print a message of the same content instead of displaying the message on the display unit. Further alternatively, an audible prompt could be issued.

The automatic configuration unit 22 then receives the user response to the prompt, and sets the received configuration information according to the host device 1 command when automatic configuration is selected. As a result, network information such as the IP address and information related to operating conditions are set suitably according to the LAN 3 environment, enabling the printer 2 to be used. A response reporting completion of automatic configuration is also sent to the host device 1. The automatic configuration process does not execute if the user cancels configuration.

As described above, when printer 2C is installed to the example shown in FIG. 4 and printer 2B of the same model is not running (has been removed), the settings for printer 2B are transferred directly to printer 2C. In this case, the information for printer ID B is found in the example shown in FIG. 2, and this information is sent to printer 2C and set.

Note, further, that the automatic configuration unit 22 could automatically configure the printer 2 based on a command from the host device 1 without the automatic configuration unit 22 prompting the user for confirmation as described above.

In step S18 the network configuration unit 11 then runs the process to update the information stored in the configuration table 12. Note that when step S15 returns No or step S16 returns No and the process goes to step S18, the update process adds the information set in the newly installed printer 2 to the configuration table 12.

When control goes from step S17 to step S18 and completion of the automatic configuration is reported, the printer ID and operating status are updated in the record storing the information used for the newly installed printer 2. More specifically, the printer ID is set to the ID of the newly installed printer 2, and the operating status is set to ON. In the above example that uses the configuration information of printer 2B for printer 2C, the printer ID of B shown in FIG. 2 changes to a printer ID of C, and the operating status is updated to ON.

However, when completion of the automatic configuration is not reported, the update process of adding the information set in the newly installed printer 2 to the configuration table 12 may be executed or not executed.

The network inspection and automatic configuration process of the network configuration unit 11 described above executes repeatedly.

As described above, the network system according to this embodiment of the invention can automatically run a configuration process including the network information of the newly installed printer 2 using the information for a previous printer 2 that was used on the same network, and can therefore easily perform a configuration process appropriate to the environment without requiring manual intervention. The work of a specialist required by the related art can therefore be eliminated.

Furthermore, by using the automatic configuration mode described above, the user can first select whether or not to enable the automatic configuration mode, and accidentally performing the automatic configuration process when not appropriate can be prevented. For example, mistakenly setting (transferring) the configuration information for a printer 2 that is simply turned off and will be used again to a new printer 2 can be prevented by disabling the automatic configuration mode when a printer that can use the configuration information on another printer is clearly not present. In addition, by not enabling the automatic configuration mode, mistakenly changing the settings of a new printer 2 that was specifically manually configured can be prevented.

In addition, because the printer 2 displays a prompt and waits for user confirmation when an automatic configuration command is sent from the host device 1, the process can be prevented from executing accidentally because reconfirmation of automatic configuration is required.

Note, further, that the network device is a printer in the embodiment described above, but the invention is not so limited and can be applied to other network devices including scanners, projectors, and facsimile machines.

The invention having being thus described, it will be apparent from the foregoing description that that the invention may be varied in many ways. Any and all such variations within the scope of the following claims are intended to be within the spirit and scope of the invention.

What is claimed is:

1. A network system comprising:
a first network device connected to a network;
a second network device connected to the network; and
a host device that is connected to the first network device and second network device over the network, the host device including
a storage unit that stores configuration information including network information of the first network device,
an acquisition unit that acquires information related to the operating status of the first network device, and
a network configuration unit that instructs the second network device to configure itself using the configuration information of the first network device stored in the storage unit when information related to the operating status of the first network device acquired by the acquisition unit indicates that the first network device is not operating.

2. The network system described in claim 1, wherein:
the acquisition unit acquires information related to the operating status of the first network device when the second network device is connected to the network; and
the network configuration unit instructs the second network device to configure itself using the configuration information of the first network device based on information related to the operating status of the first network device acquired by the acquisition unit when the second network device is connected to the network.

3. The network system described in claim 1, wherein the first network device and the second network device are the same model.

4. The network system described in claim 1, wherein the network information includes an IP address.

5. The network system described in claim 4, wherein the network configuration unit detects the IP address of the second network device when the second network device is connected to the network, and if the detected IP address of the second network device is a predetermined IP address, the network configuration unit instructs the second network device to configure itself using the configuration information of the first network device.

6. The network system described in claim 1, wherein the first network device and second network device are printers.

7. The network system described in claim 1, wherein the second network device has an automatic configuration mode that configures settings when instructed to configure itself using the configuration information of the first network device by the network configuration unit of the host device.

8. The network system described in claim 7, wherein the network configuration unit of the host device detects the automatic configuration mode setting of the second network device, and instructs the second network device to configure itself using the configuration information of the first network device when the automatic configuration mode is enabled.

9. The network system described in claim 1, wherein the second network device has a report unit that reports when setting the configuration information is instructed by the host device.

10. A network configuration method comprising steps of:
storing in a host device configuration information including network information of a first network device;
detecting the operating status of the first network device connected to a network;
detecting if the first network device is operating when a second network device is connected to the network; and
commanding, using the host device, the second network device connected to the network to configure itself using the configuration information of the first network device when the first network device is determined to be not operating.

11. The network configuration method described in claim 10, further comprising:
determining, using the host device, if the second network device connected to the network is the same model as the first network device.

12. The network configuration method described in claim 10, further comprising:
determining, using the host device, if the second network device is set to an automatic configuration mode that sets the configuration information specified by the host device;
wherein the second network device configures itself when commanded using the configuration information using the automatic configuration mode.

13. The network configuration method described in claim 10, wherein the network information is an IP address.

14. The network configuration method described in claim 13, further comprising:
detecting the IP address of the second network device, when the second network device is connected to the network.

15. The network configuration method described in claim 10, wherein the first network device and second network device are printers.

16. The network configuration method described in claim 10, wherein the second network device reports to a user when setting the configuration information is commanded by the host device.

17. A network configuration device comprising:
a storage unit that stores configuration information including network information of a first network device connected through a network;
an acquisition unit that acquires information related to the operating status of the first network device;
a detection unit that detects connection of a second network device to the network; and
a network configuration unit that instructs the second network device to configure itself using the configuration information of the first network device stored in the storage unit when the detection unit detects the second network device was connected to the network and information related to the operating status of the first network device acquired by the acquisition unit indicates that the first network device is not operating.
